(19) United States
(12) Patent Application Publication
(10) Pub. No.: US 2010/0108856 A1
(43) Pub. Date: May 6, 2010

(54) HEIGHT ADJUSTMENT APPARATUS FOR PROJECTOR

(75) Inventor: JIAN-WEI WU, Foshan (CN)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/346,793

(22) Filed: Dec. 30, 2008

(30) Foreign Application Priority Data
Oct. 31, 2008 (CN) 200810305348.6

(51) Int. Cl. F16M 11/24

(52) U.S. Cl. 248/677

(57) ABSTRACT

A height adjustment apparatus for a projector includes a lifting member and an engaging member. The projector includes a front wall and a bottom wall substantially perpendicular to the front wall. The front wall defines a sliding slot extending along a direction substantially perpendicular to the bottom wall and an opening extending through the bottom wall of the sliding slot. The lifting member includes a lifting portion slidable along the sliding slot, the lifting portion includes two side walls, each side wall includes a toothed surface The engaging member is corresponding to the opening, the engaging member includes a main body and two deformable arms extending into the sliding slot. Each deformable arm includes an engaging portion for engaging with one of the toothed surfaces.

### TECHNICAL FIELD

The present disclosure relates to projectors and, particularly, to a height adjustment apparatus used for a projector.

### DESCRIPTION OF THE RELATED ART

In general, projectors may require height adjustment for proper display. One form of adjustment in use is a hanging fixture suspending the projector from the ceiling. This fixture is inconvenient for height adjustment. In another common solution, projectors are placed on a table and are accordingly height-adjusted by way of one or more threaded posts adjustably extending downward from the underside of the projector. This is also an inconvenient operation and the height of the projector cannot be adjusted quickly.

What is needed, therefore, is a height adjustment apparatus for a projector which can provide a convenient way of adjusting the height of a projector or other applicable devices.

### BRIEF DESCRIPTION OF THE DRAWINGS

Many aspects of the present height adjustment apparatus for projector can be better understood with reference to the accompanying drawings. The components in the drawing are not necessarily drawn to scale, the emphasis instead being placed upon clearly illustrating the principles of the present height adjustment apparatus for projector.

FIG. 1 is an isometric view of a projector according to a first exemplary embodiment.

FIG. 2 is a partial, isometric, and exploded view of a height adjustment apparatus of the projector of FIG. 1.

FIG. 3 is an isometric, assembled view of the height adjustment apparatus of FIG 2.

FIG. 4 is an isometric, assembled view of the height adjustment apparatus of FIG. 2, viewed from another perspective different from FIG. 3.

FIG. 5 is an isometric view of the height adjustment apparatus of FIG. 2, showing the height adjustment apparatus in use.

FIG. 6 is an isometric view of a projector according to a second embodiment.

FIG. 7 is an isometric view of a projector according to a third embodiment.

### DETAILED DESCRIPTION OF THE EMBODIMENTS

Embodiments of the present disclosure will now be described in detail below, with reference to the accompanying drawings.

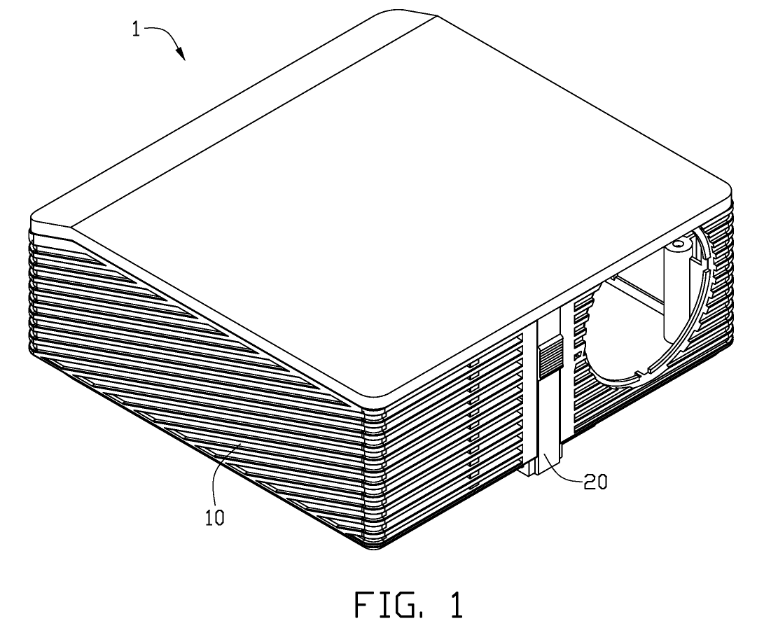

Referring to FIG. 1, a projector 1 according to a first exemplary embodiment includes a casing 10 and a height adjustment apparatus 20 engaged with the casing 10.

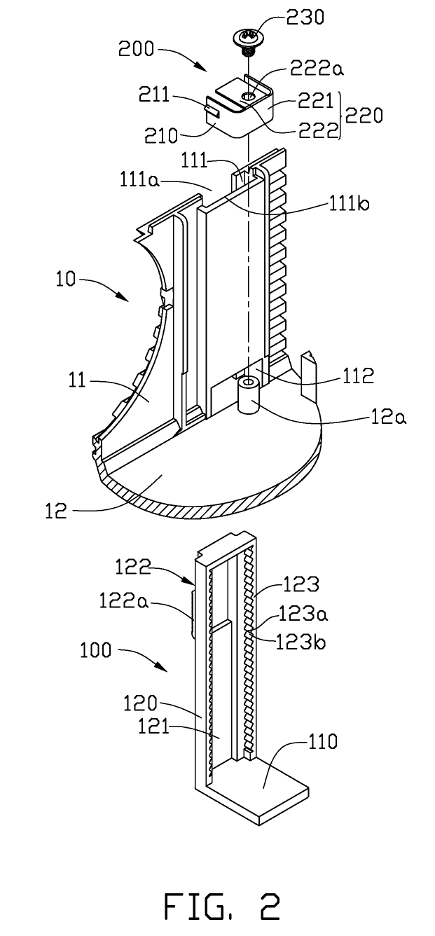

Referring to FIG. 2, the casing 10 includes a front wall 11 and a bottom wall 12 substantially perpendicular to the front wall 11. The front wall 11 defines a sliding slot 111 extending along a direction substantially perpendicular to the bottom wall 12. The sliding slot 111 has an opening 111a and a bottom wall 111b, the width of the opening 111a is smaller than the width of the bottom wall 111b. In the present embodiment, the cross-section of the sliding slot 111 is substantially T-shaped. The front wall 11 also defines an opening 112 adjacent to the bottom wall 12 and extending through the bottom wall 111b of the sliding slot 111. The bottom wall 12 defines a screw receiving portion 12a formed on a portion adjacent to the opening 112 of the front wall 11.

The height adjustment apparatus 20 includes a lifting member 100 engaged with the sliding slot 111 of the front wall 11, and an engaging member 200 engaged with the opening 112 of the front wall 11.

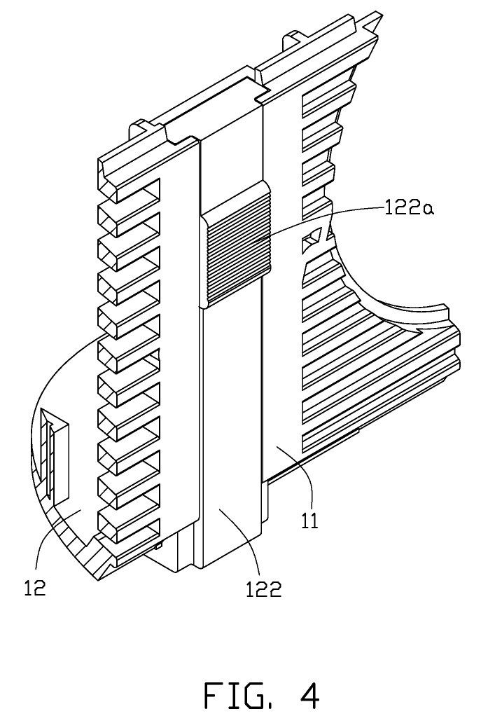

Referring to FIGS. 2 and 4, in the present embodiment, the lifting member 100 is of substantially L-shaped configuration. The lifting member 100 includes a base 110 substantially parallel to the bottom wall 12 and a lifting portion 120 substantially perpendicular to the base 110. When the lifting member 100 is assembled to the casing 10, the base 110 and the bottom wall 12 are located at a same side of the lifting portion 120. The base 110 is configured for supporting the lifting portion 120. In the other embodiments, the base 110 can be omitted.

The lifting portion 120 can slide along the sliding slot 111 on the front wall 11. The shape of the lifting portion 120 is similar to that of the sliding slot 111. The size of the lifting portion 120 is substantially equal to that of the sliding slot 111. The lifting portion 120 includes a first surface 121 facing the front wall 11 and a second surface 122 opposite to the first surface 121. The lifting portion 120 includes two opposite sidewalls 123 extending from two opposite ends of the first surface 121 and substantially perpendicular to the base 110. Each sidewall 123 includes a toothed inner surface 123a including notches 123b for engaging with the engaging member 200. The notches 123b are substantially parallel to the bottom wall 12. The lifting portion 120 also includes an operation portion 122a formed on the second surface 122 for moving the lifting portion 120 relative to the sliding slot 111 of the front wall 11 by a force applied on the operation portion 122a. The operation portion 122a can be a protrusion, or a skid-resisting area. In the present embodiment, the operation portion 122a is a protrusion with a skid-resisting structure on the surface thereof.

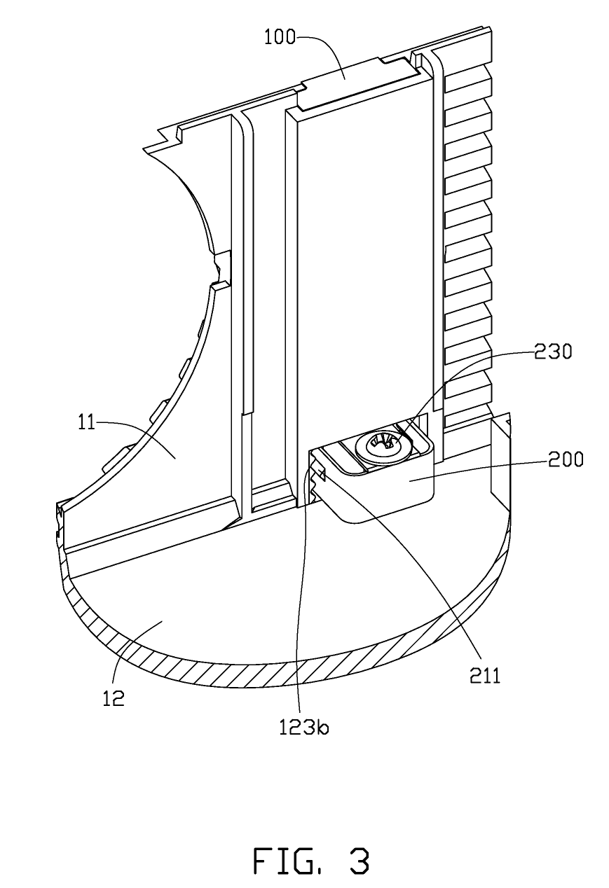

Referring to FIGS. 2 and 3, the engaging member 200 is received in the opening 112 of the front wall 11 and secured on an inner surface of the bottom wall 12. The engaging member 200 includes a main body 220, and two deformable arms 210.

In the present embodiment, the main body 220 includes a sidewall 221 substantially parallel to the front wall 11 of the casing 10, and a top wall 222 substantially perpendicular to the sidewall 221 and parallel to the bottom wall 12 of the casing 10. The top wall 222 defines a through hole 222a corresponding to the screw receiving portion 12a of the bottom wall 12. The main body 220 is secured on the bottom wall 12 by extending a screw 230 through the through hole 222a into the screw receiving portion 12a.

The two deformable arms 210 extend from two opposite ends of the sidewall 221 of the main body 220 towards the front wall 11. Each deformable arm 210 includes an engaging portion 211 formed on the outer surface thereof to engage with the notches 123b of the toothed inner surface 123a. The two deformable arms 210 extend into the sliding slot 111 through the opening 112 to engage with the toothed inner surfaces 123a of the sidewalls 123. In the present embodiment, the distance between the two deformable arms 210 is less than the distance between the two sidewalls 123 of the lifting portion 120. Each engaging portion 211 is formed on the outer surface of the corresponding deformable arm 210 facing corresponding sidewall 123 of the lifting portion 120. The deformable arms 210 can be made of elastic material, such as metal, plastic and so on.

The height adjustment apparatus 20 can be easily assembled on the projector 1. The process of assembling the height adjustment apparatus 20 on the projector 1 mainly includes three steps. Firstly, securing the engaging member 200 onto the bottom wall 12 via inserting the two deformable arms 210 through the opening 112 and into the sliding slot 111. Secondly, inserting the lifting portion 120 of the lifting member 100 into the sliding slot 111. At last, inserting the screw 230 through the through hole 222a and into the screw receiving portion 12a. Thus, the assembly of the height adjustment apparatus 20 and the casing 10 is obtained.

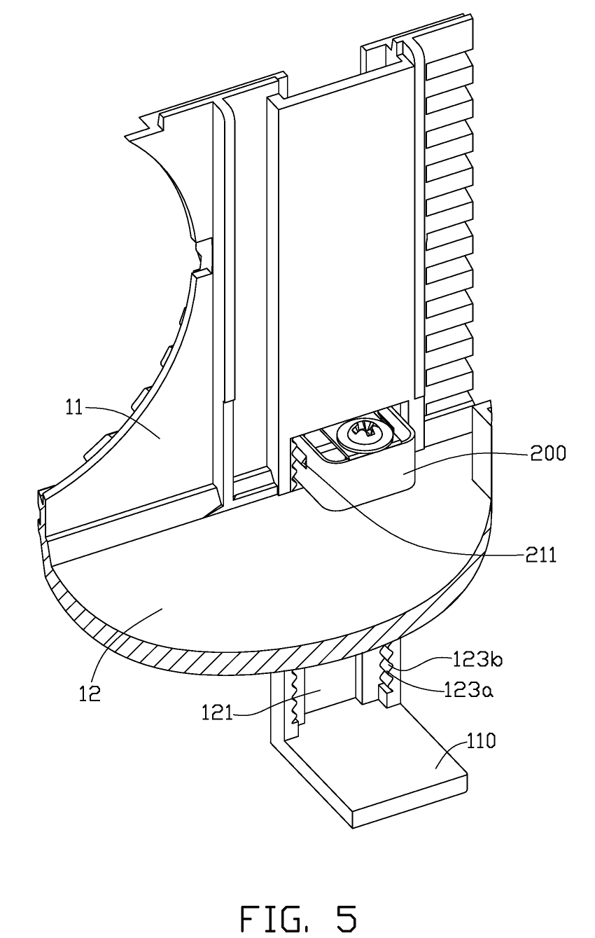

Further referring to FIG. 5, the lifting portion 120 of the lifting member 100 is pushed to slide a distance along the sliding slot 111 of the front wall 11 towards the bottom wall 12 until the engaging portion 211 engages with the corresponding notch 123b of the toothed inner surface 123a. Thus the height of the projector 1 is increased. Contrarily, when the lifting portion 120 of the lifting member 100 is pushed to slide along the sliding slot 111 of the front wall 11 away from the bottom wall 12 until the engaging portion 211 again engage with the corresponding notch 123b of the toothed inner surface 123a, the height of the projector 1 is decreased. In order that the lifting member 100 can support the projector 1, the force capable of deforming the deformable arms 210 to separate the engaging portion 211 and the notches 123b should be greater than the force exerted by the weight of the projector 1.

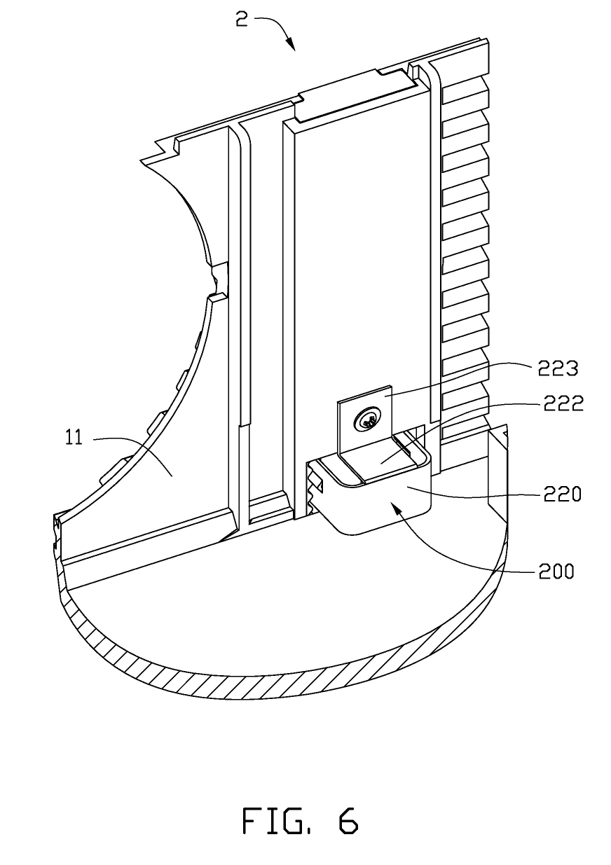

Referring to FIG. 6, a projector 2 according to a second exemplary embodiment is shown. The projector 2 is similar to the projector 1 of the first exemplary embodiment. The difference between the projector 2 and the projector 1 is that, the screw receiving portion 12a is omitted, and the main body 220 of the engaging member 200 is fixed to the front wall 11. In the projector 2, the main body 220 further includes a securing portion 223 extending from an end of the top wall 222 along a direction parallel to the front wall 11. A through hole (not labeled) is formed on the securing portion 223, while the front wall 11 also defines a hole corresponding to the through hole of the securing portion 223, thereby the engaging member 200 is fixed to the front wall 11 by inserting screws through the through hole and into the hole of the front wall 11.

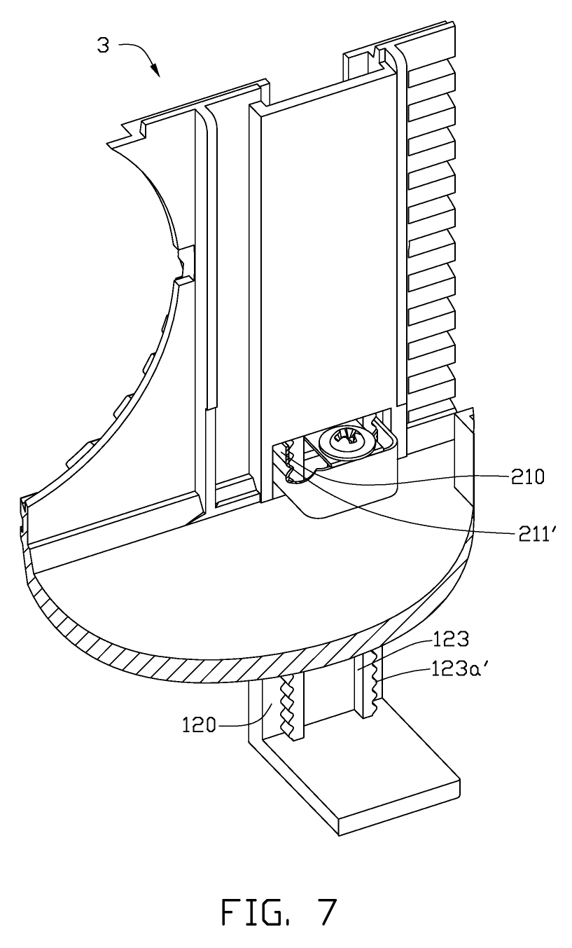

Referring to FIG. 7, a projector 3 according to a third exemplary embodiment is shown. The projector 3 is similar to the projector 1 of the first exemplary embodiment. The difference between the projector 3 and the projector 1 is that the distance between two deformable arms 210 is greater than the distance between the two sidewalls 123 of the lifting portion 120. Each sidewall 123 has a toothed outer surface 123a′, while each deformable arm 210 has an engaging portion 211′ on the inner surface thereof for engaging with the toothed outer surface 123a′ of the sidewall 123.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A height adjustment apparatus for a projector, the projector comprising a front wall and a bottom wall substantially perpendicular to the front wall, the front wall defining a sliding slot extending along a direction substantially perpendicular to the bottom wall and an opening extending through the bottom wall of the sliding slot, the height adjustment apparatus comprising:
a lifting member comprising a lifting portion slidable along the sliding slot, the lifting portion comprising two side walls, each side wall comprising a toothed surface; and
an engaging member corresponding to the opening, the engaging member comprising a main body and two deformable arms extending into the sliding slot, each deformable arm comprising an engaging portion for engaging with one of the toothed surfaces.

2. The height adjustment apparatus as claimed in claim 1, wherein the lifting portion comprises a first surface facing the front wall and a second surface opposite to the first surface, the two side walls extend from the first surface of the lifting portion.

3. The height adjustment apparatus as claimed in claim 2, wherein each toothed surface is formed on the outer surface of the corresponding sidewall, and each engaging portion is formed on the inner surface of the corresponding deformable arm.

4. The height adjustment apparatus as claimed in claim 2, wherein each toothed surface is formed on the inner surface of the corresponding sidewall, and each engaging portion is formed on the outer surface of the corresponding deformable arm.

5. The height adjustment apparatus as claimed in claim 1, wherein the main body of the engaging member is secured to the front wall of the projector.

6. The height adjustment apparatus as claimed in claim 1, wherein the main body of the engaging member is secured to the bottom wall of the projector.

7. The height adjustment apparatus as claimed in claim 1, wherein the lifting member further comprises a base substantially perpendicularly to lifting portion for supporting the lifting portion.

8. The height adjustment apparatus as claimed in claim 7, wherein the base and the bottom wall of the projector are located at the same side of the lifting portion.

9. The height adjustment apparatus as claimed in claim 1, wherein the deformable arms are made of metal or plastic.

10. The height adjustment apparatus as claimed in claim 2, wherein the second surface of the lifting portion comprises an operation portion for moving the lifting portion.

11. A projector comprising:
a front wall and a bottom wall substantially perpendicular to the front wall, the front wall defining a sliding slot extending along a direction substantially perpendicular to the bottom wall and an opening extending through the bottom wall of the sliding slot;
a height adjustment apparatus comprising:
a lifting member comprising a lifting portion slidable along the sliding slot, the lifting portion comprising two side walls, each side wall comprising a toothed surface; and
an engaging member corresponding to the opening, the engaging member comprising a main body and two deformable arms extending into the sliding slot, each deformable arm comprising an engaging portion for engaging with one of the toothed surfaces.

12. The projector as claimed in claim 11, wherein the lifting portion comprises a first surface facing the front wall and a second surface opposite to the first surface, the two side walls extend from the first surface of the lifting portion.

13. The projector as claimed in claim 12, wherein each toothed surface is formed on the outer surface of the corresponding sidewall, and each engaging portion is formed on the inner surface of the corresponding deformable arm.

14. The projector as claimed in claim 12, wherein each toothed surface is formed on the inner surface of the corresponding sidewall, and each engaging portion is formed on the outer surface of the corresponding deformable arm.

15. The projector as claimed in claim 11, wherein the main body of the engaging member is secured to the front wall of the projector.

16. The projector as claimed in claim 11, wherein the main body of the engaging member is secured to the bottom wall of the projector.

17. The projector as claimed in claim 11, wherein the lifting member further comprises a base substantially perpendicularly to lifting portion for supporting the lifting portion.

18. The projector as claimed in claim 17, wherein the base and the bottom wall of the projector are located at the same side of the lifting portion.

19. The projector as claimed in claim 11, wherein the deformable arms are made of metal or plastic.

20. The projector as claimed in claim 12, wherein the second surface of the lifting portion comprises an operation portion for moving the lifting portion.
